(19) United States
(12) Patent Application Publication
(10) Pub. No.: US 2014/0023229 A1
(43) Pub. Date: Jan. 23, 2014

(54) HANDHELD DEVICE AND METHOD FOR DISPLAYING OPERATION MANUAL

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(21) Appl. No.: 13/935,513

(22) Filed: Jul. 4, 2013

(30) Foreign Application Priority Data
Jul. 20, 2012 (TW) 101126203

(51) Int. Cl. G06K 9/00

(52) U.S. Cl. CPC G06K 9/00624
USPC 382/103

(57) ABSTRACT

In a method for displaying an operation manual of a component of a product using a handheld device. An image of the component is captured by an image capturing device of the handheld device. The captured image is compared with each image template stored in an image template database to determine a matching image corresponding to the captured image in the image template database, and contents of the operation manual of the component corresponding to the matching image are displayed on a display screen of the handheld device.

### BACKGROUND

1. Technical Field

Embodiments of the present disclosure relate to a data displaying technology, particularly to a handheld device and method for displaying an operation manual on a display screen of the handheld device.

2. Description of Related Art

When a user wants to understand functions of a certain component of a product, the user has to look up the component in a paper operation manual of the product, which is inconvenient if the user is not familiar with the components. Furthermore, the operation manual may include contents in different languages, raising the cost of the product because of the paper requirements, and the paper operation manual is easily destroyed or lost. Therefore, an efficient method for displaying an operation manual is desired.

### BRIEF DESCRIPTION OF THE DRAWINGS

FIG. 1 is a block diagram of a handheld device including a manual content display system.

FIG. 2 is a block diagram of function modules of the manual content display system included in the handheld device.

FIG. 3 is a flowchart of a method for displaying contents of an operation manual of a component on a display screen of the handheld device.

FIG. 4 is a schematic diagram of an image template database storing a plurality of image templates of components of different product types.

FIG. 5 is a schematic diagram of an identification of a product type by scanning a barcode of a product.

FIG. 6A and FIG. 6B are schematic diagrams of a display of a captured image of a component in a preset detection area.

FIG. 7 is a schematic diagram of a comparison of the captured image with each image template stored in the image template database.

FIG. 8A and FIG. 8B are schematic diagrams of contents of an operation manual of the component displayed on a display screen.

### DETAILED DESCRIPTION

All of the processes described below may be embodied in and fully automated via function code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive, or other suitable storage medium.

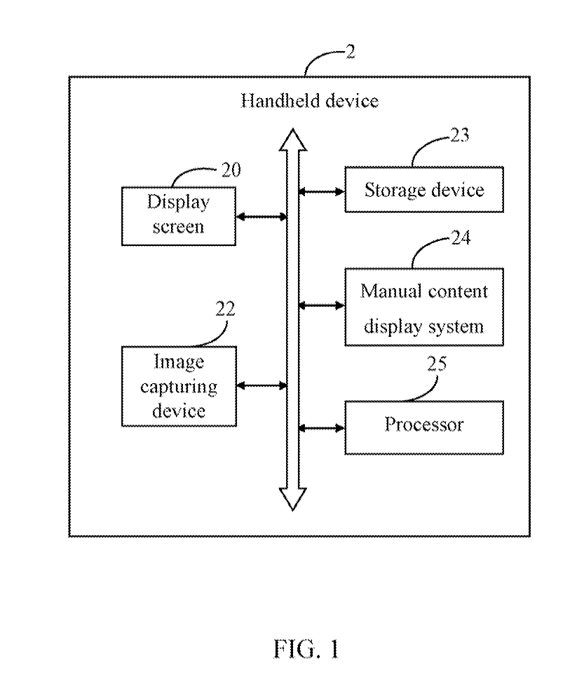

FIG. 1 is a block diagram of a handheld device including a manual content display system 24. The handheld device 2 further includes a display screen 20, an image capturing device 22, a storage device 23, and at least one processor 25. FIG. 1 illustrates only one example of the handheld device 2 that may include more or fewer components than illustrated or have a different configuration of the various components in other embodiments. The display screen 20 may be a touch panel such as a capacitive multi-touch panel.

In one embodiment, the handheld device 2 is a smart phone. The image capturing device 22 is used to capture an image of a component of a product and store the captured image in the storage device 23.

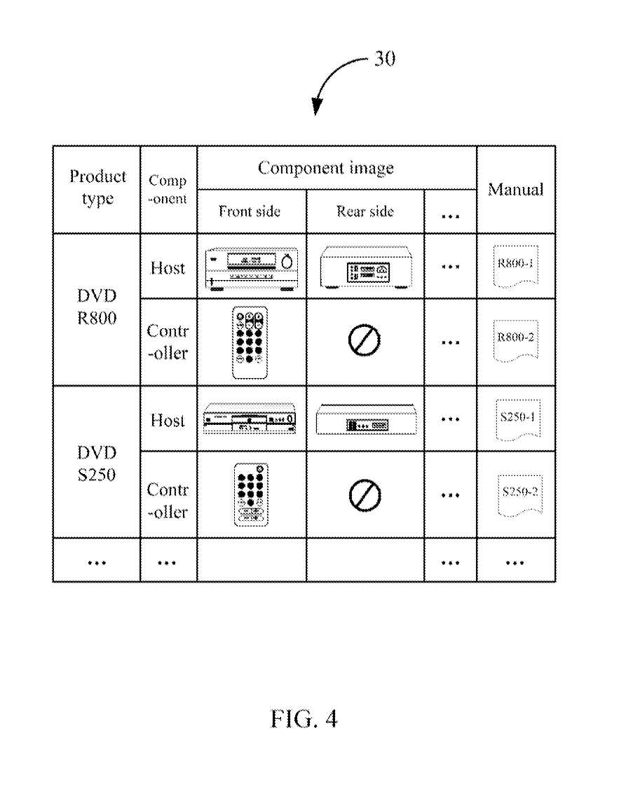

In one embodiment, the storage device 23 may be a smart media card, a secure digital card, a compact flash card, or any other memory storage device. The storage device 23 stores source codes of the manual content display system 24 and an image template database 30. The information stored in the image template database 30 is downloaded from a remote server through a network. For example, as shown in FIG. 4, the image template database 30 stores images of components (image templates) of different product types and the operation manual of each component. The image template database 30 has a plurality of columns including a product type (e.g., DVD R800), a name of the component (e.g., controller), an image of the component, and an operation manual of the component.

In one embodiment, the image template database 30 is stored in the remote server, and the handheld device 2 downloads the information of the image template database 30 from the remote server. In this embodiment, the image template database 30 records a storage path of the image of each component, such as E:\Template\DVDR800\Image\HostObversejpg, and records a storage path of the operation manual of each component such as E:\Template\DVDR800\Manual\ HostObverse.txt.

In one embodiment, the manual content display system 24 may be downloaded from the remote server through a network module of the handheld device 2. In other embodiments, the image template database 30 does not need to be stored in a local storage (e.g., the storage device 23) of the handheld device 2, and the handheld device 2 accesses the information of the image template database 30 from the remote server through the network module of the handheld device 2.

The manual content display system 24 is used to automatically obtain the operation manual of the component from the image template database 30, and display contents of the operation manual of the component on the display screen 20 of the handheld device 2. In one embodiment, the manual content display system 24 includes computerized instructions in the form of one or more programs that are executed by the processor 25 and stored in the storage device 23 (or memory).

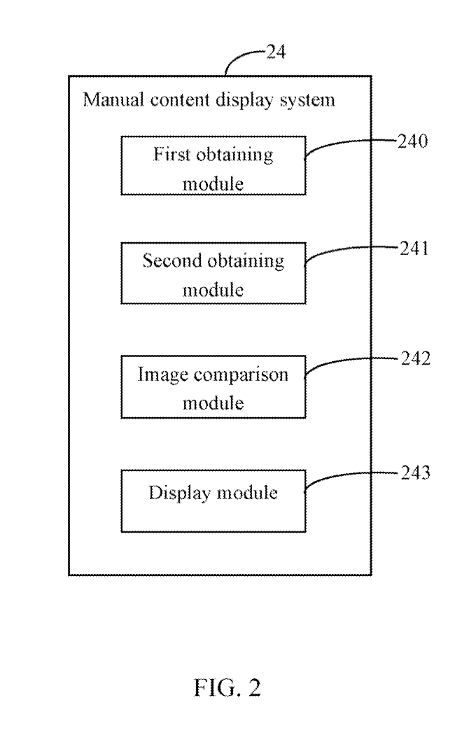

FIG. 2 is a block diagram of function modules of the manual content display system 24 included in the handheld device 2. In one embodiment, the manual content display system 24 includes one or more modules, for example, a first obtaining module 240, a second obtaining module 241, an image comparison module 242, and a display module 243. In general, the word “module”, as used herein, refers to logic embodied in hardware, firmware, or to a collection of software instructions written in a programming language such as Java, C, or assembly. One or more software instructions in the modules are embedded in firmware such as in an EPROM. The modules described herein are implemented as software and/or hardware modules and are stored in any type of non-transitory computer-readable medium or other storage device. Some non-limiting examples of non-transitory computer-readable medium include CDs, DVDs, BLU-RAY, flash memory, and hard disk drives.

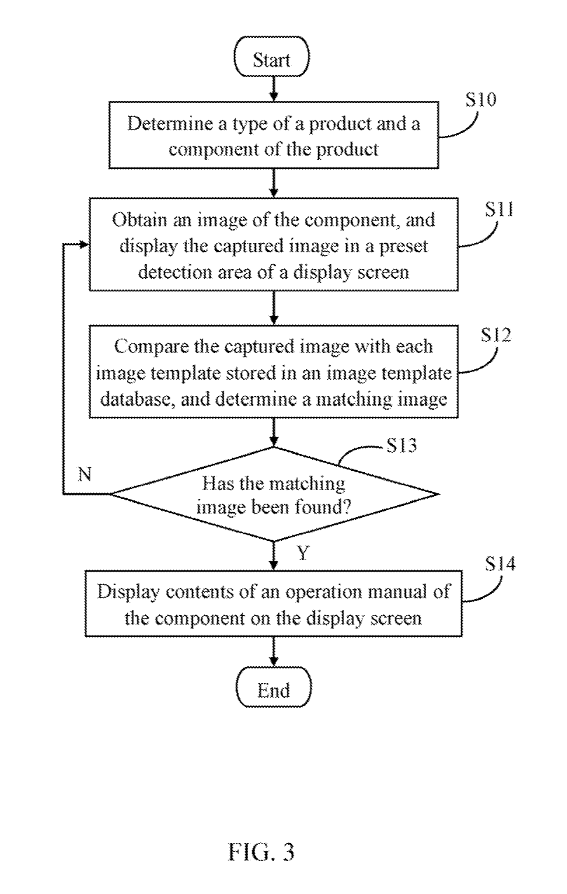

FIG. 3 is a flowchart of one embodiment of a method for displaying contents of an operation manual of a component on the display screen 20 of the handheld device 2. Depending on the embodiment, additional steps may be added, others removed, and the ordering of the steps may be changed.

In step S10, the first obtaining module 240 determines a type of a product (product type) that needs to be looked up and a target component (hereafter referred to as the component) of the product. Two methods for obtaining the product type are provided as follows.

In a first method of a manual selection , the handheld device 2 displays a list (e.g., a pull down list) including a plurality of product types. The first obtaining module 240 obtains one product type that needs to be looked up in response to receiving a user selection from the list.

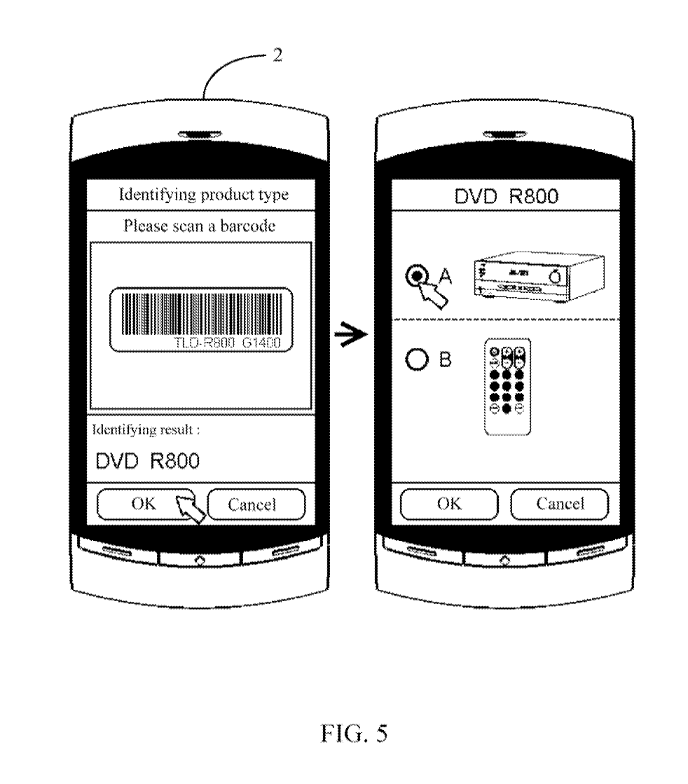

In a second method of an automatic selection, as shown in FIG. 5, the user scans a barcode of the product, then, the first obtaining module 240 automatically identifies the product type from the barcode and displays images of all the components of the product type on the display screen 20, such as an image of the front side of a host or an image of a controller. The user then selects a check box “A” to select the image of the front side of the host.

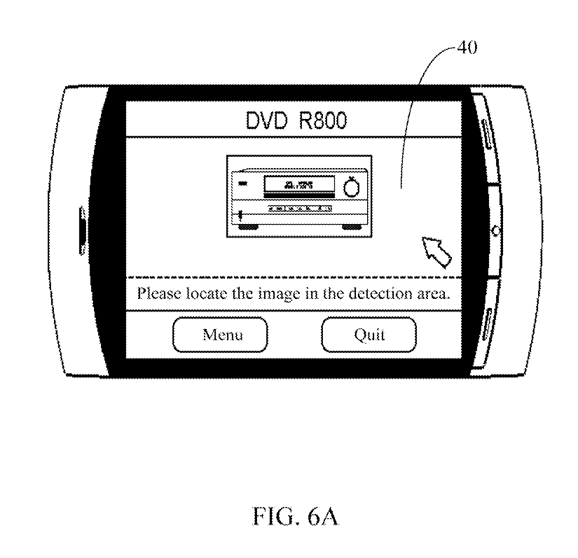

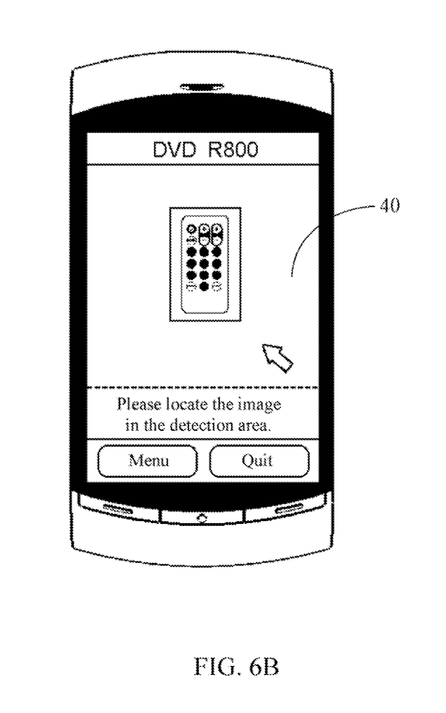

In step S11, the second obtaining module 241 obtains an image of the component captured by the image capturing device 22, and displays the captured image in a preset detection area 40 of the display screen 20. For example, as shown in FIG. 6, when the user needs to look up a component, the second obtaining module 241 displays a prompt message on the display screen 20 to capture an image of the component. A lens of the image capturing device 22 is adjusted to display the image in the preset detection area 40 to be captured.

In one embodiment, the second obtaining module 241 adjusts a display size and a display shape (e.g., a square or a rectangle) of the preset detection area 40 according to the product type and shape of the component. The second obtaining module 241 then outputs a message to the display screen 20 to prompt the user to adjust a direction (horizontal direction or vertical direction) of the handheld device 2 according to the product type and the shape of the component. For example, if the user selects the check box “A” (i.e., an image of the front side of the host of DVDR800) in FIG. 5, the preset detection area 40 is displayed as shown in FIG. 6A. If the user selects the check box “B” (i.e., an image of the controller of DVDR800), as shown in FIG. 5, the preset detection area 40 is displayed as shown in FIG. 6B.

In step S12, the image comparison module 242 compares the captured image in the preset detection area 40 with each image template stored in the image template database 30, and determines a matching image corresponding to the captured image in the image template database 30.

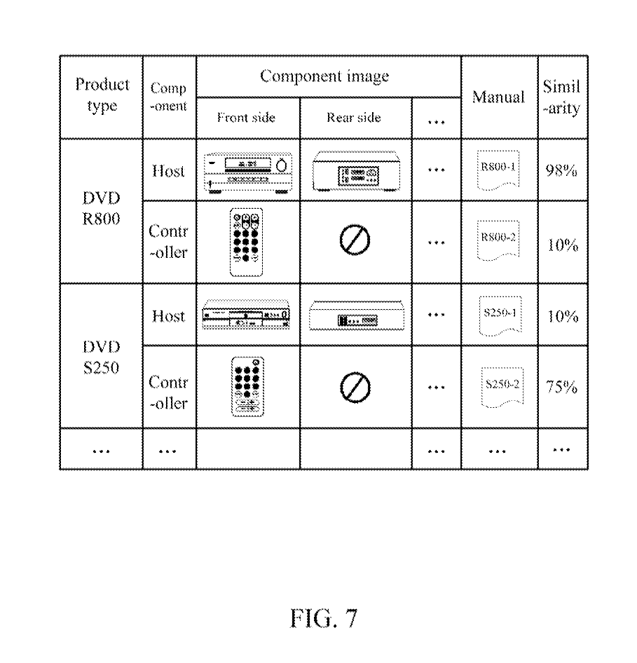

In one embodiment, the image comparison module 242 calculates a similarity between the captured image and each image template stored in the image template database 30 and determines a specified image template as the matching image upon the condition that the similarity between the captured image and the specified image template is greater than a preset value (e.g., 95%). If a number of the determined image templates is greater than one, the image template that has the highest similarity is determined to be the matching image. For example, if the captured image is the one shown in FIG. 6A, the similarity between the captured image and each image template is shown in FIG. 7. As shown in FIG. 7, the image of the front side of the host of DVDR800 has the highest similarity (98%), thus, the image of the front side of the host of DVDR800 is determined to be the matching image. A method of calculating a similarity between two images is found in US 20100177967A1, which has a publication date of Jul. 15, 2010.

In step S13, the image comparison module 242 determines whether a matching image has been found. If the matching image has not been found, the procedure returns to step S11 and the image comparison module 242 outputs a prompt message to the display screen 20 to prompt the user to capture the image of the component again. If the matching image has been found, the procedure goes to step S14.

In step S14, the display module 243 displays contents of an operation manual of the component corresponding to the matching image on the display screen 20. For example, the contents of the operation manual are displayed in an augmented reality (AR) mode.

In other embodiments, if the user selects the component manually, for example, as shown in FIG. 5, the user selects the check box “A” which represents the front side of the host of DVDR800, the first obtaining module 240 obtains contents of the operation manual of the user-selected component according to a storage path of the operation manual of the user-selected component, then, and the display module 243 displays the contents of the operation manual of the user-selected component on the display screen 20 in the augmented reality mode. In the user-selection mode, the contents of the operation manual of the user-selected component are obtained accurately from the image template database 30.

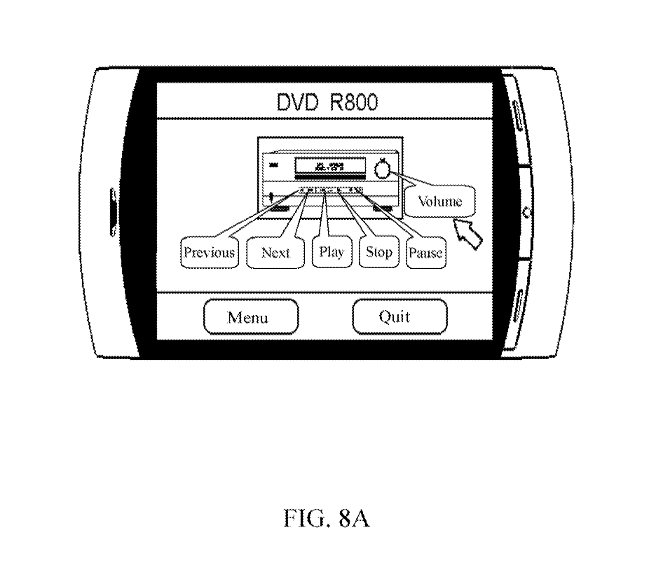

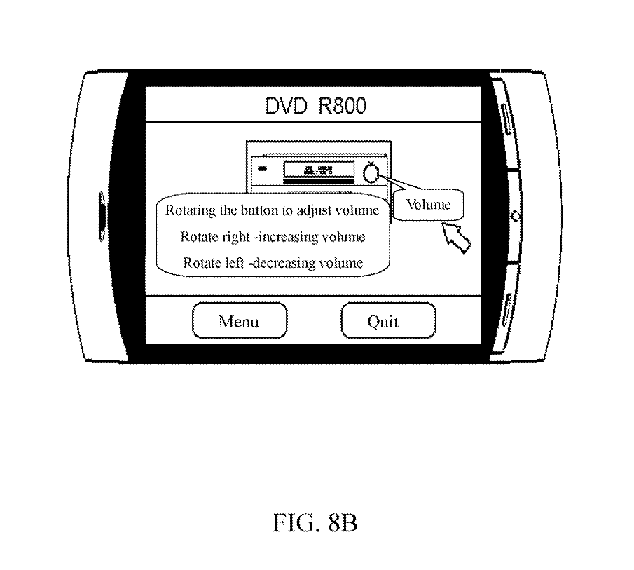

For example, as shown in FIG. 8A, an image of a component of DVDR800 is captured by the image capturing device 22 and displayed on the display screen 20. The contents of the operation manual of the component are displayed with the image of the component in the augmented reality mode on the display screen 20. When one of the soft buttons on the image of the component is selected, detailed descriptions of the function of the selected soft button are displayed on the display screen 20. As shown in FIG. 8B, when the soft button corresponding to “Volume” is selected, the detailed descriptions of the soft button “Volume” are displayed.

It should be emphasized that the above-described embodiments of the present disclosure, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method of a handheld device comprising a display screen, the method comprising:
obtaining an image of a component of a product captured by an image capturing device of the handheld device, and displaying the captured image in a preset detection area of the display screen;
comparing the captured image in the preset detection area with image templates stored in an image template database, and determining a matching image corresponding to the captured image in the image template database; and
displaying contents of an operation manual of the component corresponding to the matching image on the display screen.

2. The method according to claim 1, further comprising: determining a type of the product by scanning a barcode of the product.

3. The method according to claim 1, further comprising: adjusting a display size and a display shape of the preset detection area according to a type of the product and a shape of the component.

4. The method according to claim 1, wherein the matching image is determined by:
calculating a similarity between the captured image and each of the image templates stored in the image template database; and
determining a specified image template as the matching image upon the condition that the similarity between the captured image and the specified image template is greater than a preset value.

5. The method according to claim 1, wherein the contents of the operation manual of the component are displayed on the display screen in an augmented reality mode.

6. A handheld device, comprising:
a processor;
a display screen;
a storage device storing a plurality of instructions, which when executed by the processor, causes the processor to:
obtain an image of a component of a product using an image capturing device of the handheld device, and display the captured image in a preset detection area of the display screen;
compare the captured image in the preset detection area with image templates stored in an image template database, and determine a matching image corresponding to the captured image in the image template database; and
display contents of an operation manual of the component corresponding to the matching image on the display screen.

7. The handheld device according to claim 6, wherein the plurality of instructions further comprise: determining a type of the product by scanning a barcode of the product.

8. The handheld device according to claim 6, wherein the plurality of instructions further comprise: adjusting a display size and a display shape of the preset detection area according to a type of the product and a shape of the component.

9. The handheld device according to claim 6, wherein the matching image is determined by:
calculating a similarity between the captured image and each of the image templates stored in the image template database; and
determining a specified image template as the matching image upon the condition that the similarity between the captured image and the specified image template is greater than a preset value.

10. The handheld device according to claim 6, wherein the contents of the operation manual of the component are displayed on the display screen in an augmented reality mode.

11. A non-transitory storage medium having stored thereon instructions that, when executed by a processor of a handheld device, causes the handheld device to perform a method, the method comprising:
obtaining an image of a component of a product captured by an image capturing device of the handheld device, and displaying the captured image in a preset detection area of a display screen of the handheld device;
comparing the captured image in the preset detection area with image templates stored in an image template database, and determining a matching image corresponding to the captured image in the image template database; and
displaying contents of an operation manual of the component corresponding to the matching image on the display screen.

12. The non-transitory storage medium according to claim 11, wherein the method further comprises: determining a type of the product by scanning a barcode of the product.

13. The non-transitory storage medium according to claim 11, wherein the method further comprises: adjusting a display size and a display shape of the preset detection area according to a type of the product and a shape of the component.

14. The non-transitory storage medium according to claim 11, wherein the matching image is determined by:
calculating a similarity between the captured image and each of the image templates stored in the image template database; and
determining a specified image template as the matching image upon the condition that the similarity between the captured image and the specified image template is greater than a preset value.

15. The non-transitory storage medium according to claim 11, wherein the contents of the operation manual of the component are displayed on the display screen in an augmented reality mode.
